(19) United States
(12) Patent Application Publication
(10) Pub. No.: US 2019/0293434 A1
(43) Pub. Date: Sep. 26, 2019

(54) SYSTEM AND METHOD FOR GUIDING USERS TO A VEHICLE

(71) Applicant: GENERAL MOTORS LLC, DETROIT, MI (US)

(72) Inventors: Marc Wiz, Austin, TX (US); Daniel J. Fagnant, Austin, TX (US)

(21) Appl. No.: 15/928,383

(22) Filed: Mar. 22, 2018

(51) Int. Cl. G01C 21/30; G01C 21/34

(52) U.S. Cl. CPC G01C 21/30; G05D 1/0088; G01C 21/3484

(57) ABSTRACT

An automotive vehicle includes at least one sensor configured to detect features in a region proximate the exterior of the vehicle. The vehicle additionally includes at least one telecommunications module configured to transmit data to and receive user data from a remote device. The vehicle further includes at least one controller. The controller is configured to receive sensor data from the at least one sensor. The controller is also configured to identify at least one physical feature in the region proximate the exterior of the vehicle based on the sensor data. The controller is additionally configured to determine a user location. The controller is further configured to determine a route from the user location to a current vehicle location, with the route not intersecting the physical feature. The controller is further configured to communicate the route to the remote device via the telecommunications module.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes at least one sensor configured to detect features in a region proximate the exterior of the vehicle. The vehicle additionally includes at least one telecommunications module configured to transmit data to and receive user data from a remote device. The vehicle further includes at least one controller. The controller is configured to receive sensor data from the at least one sensor. The controller is also configured to identify at least one physical feature in the region proximate the exterior of the vehicle based on the sensor data. The controller is additionally configured to determine a user location. The controller is further configured to determine a route from the user location to a current vehicle location, with the route not intersecting the physical feature. The controller is further configured to communicate the route to the remote device via the telecommunications module.

In an exemplary embodiment, the controller is configured to determine the user location based on the sensor data or the user data.

In an exemplary embodiment, the controller is further configured to, subsequent communicating the route to the remote device, receive second sensor data from the at least one sensor, determine a second user location, determine a second user route from the second user location to the current vehicle location, and, in response to the second route differing from the route, communicate the second route to the remote device via the telecommunication module

In an exemplary embodiment, the at least one sensor comprises a LiDAR module.

In an exemplary embodiment, the at least one controller is further configured to access a previously-generated feature map of the vehicle location, with the previously-generated feature map including at least one pre-mapped physical feature and being stored in nontransient data memory. The controller is additionally configured to correlate attributes of the at least one physical feature with aspects of the at least one pre-mapped physical feature, and to determine a confidence value based on the correlation.

In an exemplary embodiment, the controller is further configured to detect that a respective physical feature of the at least one physical feature is in motion based on the sensor data.

In an exemplary embodiment, the controller is further configured to access a user profile stored in nontransient data memory. The controller is configured to communicate the route to the remote device via the telecommunications module in response to a criterion associated with the user profile.

A method of controlling an automotive vehicle according to the present disclosure includes determining a current user location of a user external the vehicle. The method additionally includes determining a current vehicle location of the vehicle. The method also includes detecting, via at least one sensor coupled to the vehicle, a physical feature in a region proximate the exterior of the vehicle. The method further includes determining, via a controller coupled to the vehicle, a route from the current user location to the current vehicle location, the route not intersecting the physical feature. The method still further includes communicating, via a telecommunications module coupled to the vehicle, the route to a remote telecommunications device.

In an exemplary embodiment, determining a current user location comprises receiving the current user location from the remote telecommunications device via the telecommunications module.

In an exemplary embodiment, the method additionally includes accessing, via the controller, a previously-generated feature map of the vehicle location. The previously-generated feature map includes at least one pre-mapped physical feature and is stored in nontransient data memory. In such embodiments, the method also includes correlating, via the controller, attributes of the at least one physical feature with aspects of the at least one pre-mapped physical feature. Such embodiments additionally include determining, via the controller, a confidence value based on the correlation.

In an exemplary embodiment, the method additionally includes classifying, via the controller, the physical feature as a moving feature based on signals from the at least one sensor.

In an exemplary embodiment, the method additionally includes accessing, via the controller, a user profile stored in nontransient data memory, wherein the communicating is in response to a criterion associated with the user profile.

Embodiments according to the present disclosure provide a number of advantages. For example, the present disclosure provides a system and method for guiding a user to a vehicle. Advantageously, this may enable users having disabilities to more easily find the vehicle, increasing customer satisfaction.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a flowchart representation of a method of controlling a vehicle according to an embodiment of the present disclosure; and

FIG. 4 is a representation of a pedestrian route generated according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative.

The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

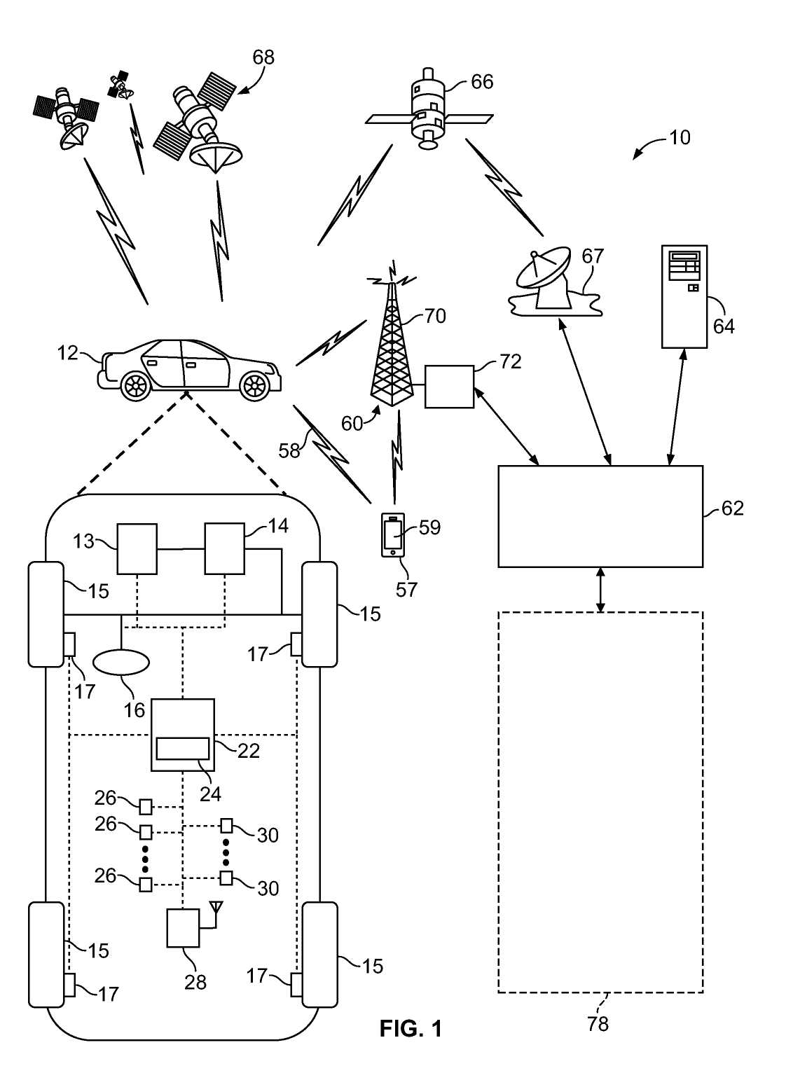

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

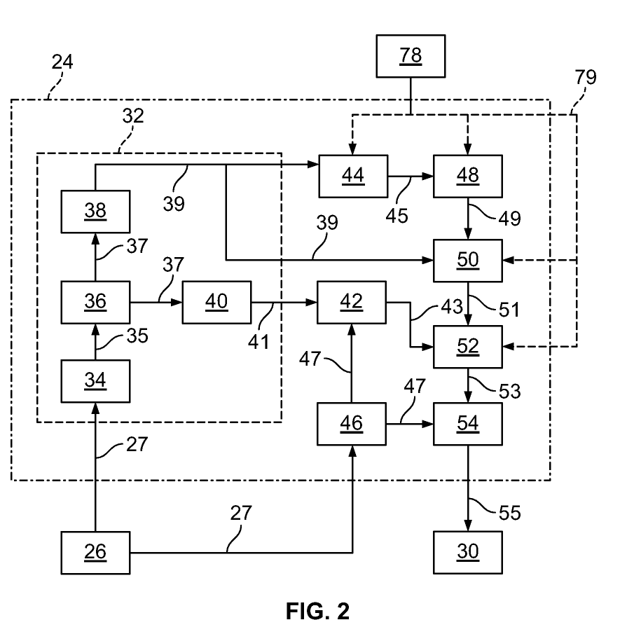

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

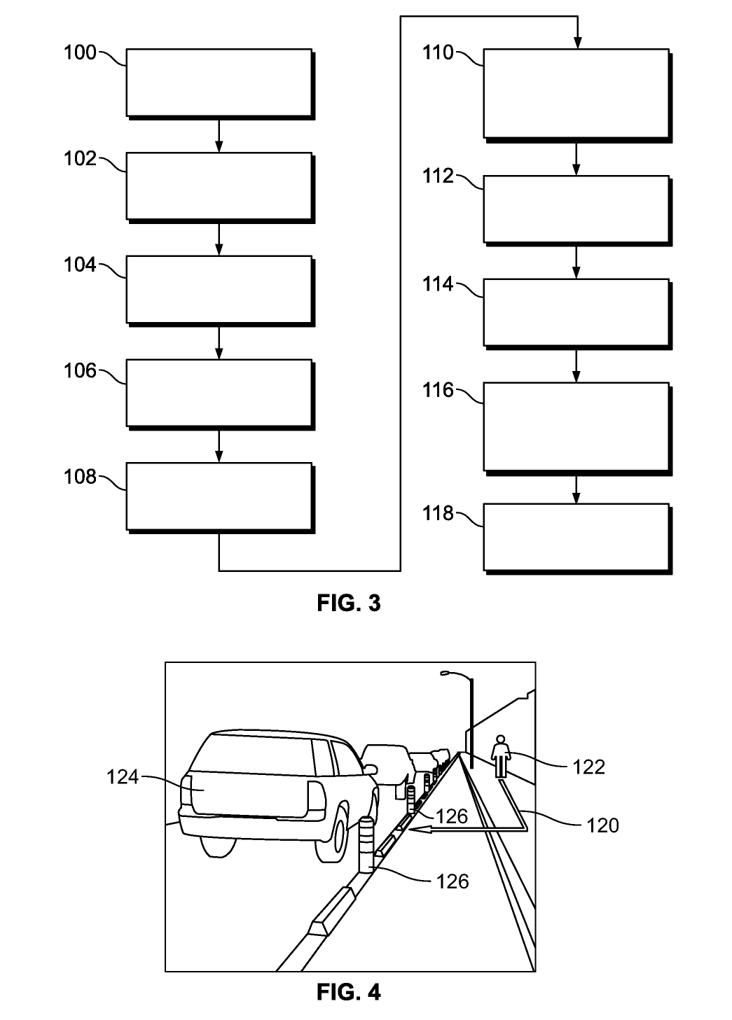

Referring now to FIG. 3, a method of controlling an automotive vehicle is illustrated in flowchart form.

A vehicle arrives at a pickup location, as illustrated at block 100. In an exemplary embodiment, the vehicle is configured generally similarly to the vehicle 12 illustrated in FIG. 1, and is under the control of an automated driving system. The pickup location refers to an end of a route segment proximate a user-requested pickup point. The pickup location may be determined by the ADS 24 based on factors including the geolocation of the user-requested pickup point, proximity of driving surfaces to the user-requested pickup point, the presence of any obstructions proximate the user-requested pickup point, and other factors. In addition, one or more user profiles associated with the user is accessed. User profiles may be stored in non-transient data memory, e.g. on the mobile device 57 or the computer 64. The user profile or profiles include one or more preferences selected by the user or users with whom the profile is associated. The preferences may include, for example, a notification preference indicating a desired intensity and type of notification. Other available characteristics associated with the user may also be stored in the user profile. In an exemplary embodiment, such characteristics include the presence of any disability of the user, such as a presence of impaired vision or personal mobility, such as a wheelchair, cane, or walker.

In some embodiments, the below-described algorithm may be conditioned upon the presence of or absence of a particular characteristic stored in the user profile. As a non-limiting example, in such embodiments the below-described algorithm may be performed only in response to a user profile indicating that the user is vision-impaired. However, in some embodiments, the below-described algorithm may be performed independent of any characteristics of the user or users.

A determination is made of a current vehicle location and a current user location, as illustrated in block 102. The current vehicle location may be determined, for example, based on inputs from the plurality of sensors 26, e.g. a GPS module. The current user location may be determined, for example, based on data received from a mobile device, e.g. the mobile device 57 illustrated in FIG. 1. In an exemplary embodiment, the current user location may be determined by the mobile device 57 and communicated to the wireless communication system 28 of the vehicle 12. However, other locating methods may be used.

Sensor readings are obtained for a region in the vicinity of the vehicle, as illustrated at block 104. In an exemplary embodiment, this is performed by one or more of the sensors 26, e.g. an optical camera or LiDAR module, under the control of the controller 22. In an exemplary embodiment, the region for which sensor readings are obtained is at least of a size to encompass the current user location and a navigable path between the current user location and the current vehicle location. However, various region sizes may be used based on factors such as sensor capability and environmental conditions.

Physical features are classified and identified based on the sensor readings, as illustrated in block 106. In an exemplary embodiment, this is performed by the controller 22. The identification may be performed by the classification and segmentation module 36 as discussed above with respect to FIG. 2, or may be performed by other modules or in conjunction with other modules as appropriate. In an exemplary embodiment, the physical features are classified according to geolocation, size, shape, other relevant parameters, or any combination thereof In some embodiments, the physical features are identified based on previously-performed guided machine learning, e.g. using a neural network trained to identify physical features commonly found near roadways. The physical features may include both non-moving physical features such as curbs, signs, and plants, and moving physical features such as pedestrians or bicyclists. Collectively, any physical features identified based on the sensor readings may be referred to as a live map.

A previously-generated feature map of the vehicle location is accessed, as illustrated in block 108. In an exemplary embodiment, this is performed by the controller 22. The previously-generated feature map may be generated by a variety of known high-definition mapping procedures, e.g. by fusing the results of one or more LiDAR scans performed on one or more previous occasions at the current vehicle location. In a first embodiment, the previously-generated feature map is stored in non-transient data memory associated with the controller 22 of the vehicle 12. In a second embodiment, the previously-generated feature map is stored on a remote non-transient data memory, e.g. associated with the computer 64, and accessed via the wireless communication system 28 of the vehicle 12. The previously-generated feature map may include one or more physical features in the vicinity of the vehicle location. The physical features may be associated with a geolocation, size, shape, other relevant parameters, or any combination thereof. In some embodiments, the physical features may be associated with an identification, as discussed above with respect to the live map. Collectively, any physical features identified in the previously-generated feature map may be referred to as a pre-map.

The live map and the pre-map are merged, as illustrated at block 110. In an exemplary embodiment, this is performed by the controller 22. The merging may include correlating features from the live map with features from the pre-map. In an exemplary embodiment, features in the live map may be weighted differently from features in the pre-map. In such embodiments, the features in the live map may be weighted more heavily than features in the pre-map. Such embodiments may therefore enable the live map to supersede the pre-map when discrepancies arise, while still including features identified in the pre-map but not in the live map. In an exemplary embodiment, a confidence metric is calculated based on the degree of correlation between a feature in the live map and the corresponding feature in the pre-map. In such embodiments, moving features such as pedestrians or bicyclists may be omitted from the confidence calculation. A combined map is thereby generated. The combined may include all physical features from the pre-map and the live map along with corresponding confidence values.

A pedestrian route is calculated from the user location to the vehicle location, as illustrated at block 112. In an exemplary embodiment, this is performed by the controller 22. The route calculation may be performed using known pathfinding principles, e.g. broadly similar to those implemented in the path planning module 50. The pedestrian route is calculated to avoid the physical features in the combined map. An example of a calculated route is illustrated in FIG. 4. A route 120 is calculated between a user 122 and the vehicle 124. The route 120 is calculated to avoid physical features 126, which in the illustrated embodiment comprise lane dividers. In an exemplary embodiment, the route 120 is also calculated to avoid predicted locations of moving physical objects, e.g. pedestrians or bicyclists.

The vehicle route is communicated to the user, as illustrated at block 114. In an exemplary embodiment, this is performed by the controller 22. In an exemplary embodiment, the communication is performed by means of the mobile device 57, e.g. through audio, text, or haptic notifications. However, other communications means are contemplated within the scope of the present disclosure. In an exemplary embodiment, the route is communicated with reference to any physical features in the pre-map which are located between the user location and the vehicle location. For physical features which have been identified, the physical feature may be referred to by name in the communication, e.g. “turn left after the tree”. For physical features which have not been identified, the physical feature may be referred to by a generic term, e.g. “turn left after the object”. For physical features having a relatively low confidence value, e.g. below 75%, the physical feature may be referred to with indefinite language, e.g. “there may be an object on the left.” The foregoing are merely exemplary communications; other terminology may, of course, be used.

The progress of the user is monitored, and the scanning, route-calculation, and communication steps are iterated, as illustrated at block 116. Any significant changes in the presence or location of physical features, e.g. change in position of a bicyclist, may thereby be detected, accounted for, and if necessary, communicated to the user.

The user then arrives at the vehicle, as illustrated at block 118, and the algorithm terminates.

As may be seen the present disclosure provides a system and method for guiding a user, e.g. a user having visual impairment or other disability, to an automotive vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one sensor configured to detect features in a region proximate the exterior of the vehicle;
at least one telecommunications module configured to transmit data to and receive user data from a remote device; and
at least one controller configured to receive sensor data from the at least one sensor, identify at least one physical feature in the region proximate the exterior of the vehicle based on the sensor data, determine a user location, determine a route from the user location to a current vehicle location, the route not intersecting the physical feature, and communicate the route to the remote device via the telecommunications module.

2. The automotive vehicle of claim 1, wherein the controller is configured to determine the user location based on the sensor data or the user data.

3. The automotive vehicle of claim 1, wherein the controller is further configured to, subsequent communicating the route to the remote device, receive second sensor data from the at least one sensor, determine a second user location, determine a second user route from the second user location to the current vehicle location, and, in response to the second route differing from the route, communicate the second route to the remote device via the telecommunication module

4. The automotive vehicle of claim 1, wherein the at least one sensor comprises a LiDAR module.

5. The automotive vehicle of claim 1, wherein the at least one controller is further configured to access a previously-generated feature map of the vehicle location, the previously-generated feature map including at least one pre-mapped physical feature and being stored in nontransient data memory, to correlate attributes of the at least one physical feature with aspects of the at least one pre-mapped physical feature, and to determine a confidence value based on the correlation.

6. The automotive vehicle of claim 1, wherein the controller is further configured to detect that a respective physical feature of the at least one physical feature is in motion based on the sensor data.

7. The automotive vehicle of claim 1, wherein the controller is further configured to access a user profile stored in nontransient data memory, and wherein the controller is configured to communicate the route to the remote device via the telecommunications module in response to a criterion associated with the user profile.

8. A method of controlling an automotive vehicle, comprising:
determining a current user location of a user external the vehicle;
determining a current vehicle location of the vehicle;
detecting, via at least one sensor coupled to the vehicle, a physical feature in a region proximate the exterior of the vehicle;
determining, via a controller coupled to the vehicle, a route from the current user location to the current vehicle location, the route not intersecting the physical feature; and
communicating, via a telecommunications module coupled to the vehicle, the route to a remote telecommunications device.

9. The method of claim 8, wherein determining a current user location comprises receiving the current user location from the remote telecommunications device via the telecommunications module.

10. The method of claim 8, further comprising:
accessing, via the controller, a previously-generated feature map of the vehicle location, the previously-generated feature map including at least one pre-mapped physical feature and being stored in nontransient data memory;
correlating, via the controller, attributes of the at least one physical feature with aspects of the at least one pre-mapped physical feature; and
determining, via the controller, a confidence value based on the correlation.

11. The method of claim 8, further comprising classifying, via the controller, the physical feature as a moving feature based on signals from the at least one sensor.

12. The method of claim 8, further comprising accessing, via the controller, a user profile stored in nontransient data memory, wherein the communicating is in response to a criterion associated with the user profile.
